(19) United States
(12) Patent Application Publication
(10) Pub. No.: US 2010/0316342 A1
(43) Pub. Date: Dec. 16, 2010

(54) PHOTONIC CRYSTAL BASED OPTICAL MODULATOR INTEGRATED FOR USE IN ELECTRONIC CIRCUITS

(76) Inventors: James A. Casey, Merrill, MI (US); Armand Rosenberg, Alexandria, VA (US); Charles R. Eddy, JR., Columbia, MD (US); Michael A. Mastro, Fairfax, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 12/482,099

(22) Filed: Jun. 10, 2009

(51) Int. Cl. G02B 6/10; B29D 11/00

(52) U.S. Cl. 385/129; 216/24

(57) ABSTRACT

A photonic crystal based optical modulator that is capable of being integrated with electronic circuits on a chip. An optical modulator is formed by using a substrate, an optical buffer layer, and optical waveguide layer and providing photonic crystal regions in the optical waveguide layer. Improved strength and durability of the optical modulator is achieved by using an electrode island to limit the suspended area to the minimum required by the photonic crystal waveguides.

### BACKGROUND OF THE INVENTION

1. Field of the Invention

The present invention is directed towards optoelectronic circuits. In particular the present invention is directed to optical modulators integrated with electronic circuits.

2. Description of the Related Technology

Mach-Zehnder modulators (sometimes referred to as interferometers) are optoelectronic devices which modulate an optical signal. An example of a Mach-Zehnder modulator 10 is illustrated in FIG. 1. In a Mach-Zehnder modulator 10 the light 2 travels from the input 4 of the modulator 10 and is split into a first path 6 and a second path 8. The light 2 is then recombined at the output 14. When the light 2 travels the second path 8 a differential electric field 12 is applied to the second path 8 of the modulator 10 in order to introduce an optical phase difference between the two paths of the modulator 10. This phase difference results from the electro-optic effect, i.e. from a change in index of refraction induced by the applied electric field 12. When the light 2 is recombined, an interference pattern is produced at the output of the modulator 10, thus allowing the continuous light wave to be modulated for use in data transmission and/or communications.

Mach-Zehnder modulators are currently found in numerous devices, such as in fiber optic telecommunications. Existing Mach-Zehnder modulators are produced using conventional optical waveguide structures, such as ridge waveguides, as basic components. Conventional Mach-Zehnder modulator design requires waveguides with widths of tens to hundreds of micrometers and lengths on the order of centimeters. These dimensions are required even when materials with large electro-optic coefficients, such as LiNbO₃, are used.

Modulators having dimensions, such as those discussed above are incompatible with on-chip integration of an optical network due to their large size. An optical network's fundamental building blocks (namely, a source, detector and modulator) must occupy a small fraction of the space associated with the chip, which is typically several square centimeters in size or less.

Therefore, there is a need in the field to minimize the size of modulators in order to make them compatible with on-chip integration in an optical network.

### SUMMARY OF THE INVENTION

An object of one aspect of the invention is to provide an optical modulator comprising a photonic crystal region.

Another object of an aspect of the invention is a method of forming an optical modulator having a photonic crystal region.

Yet another object of an aspect of the invention is an optical modulator comprising a photonic crystal region and an electrode island.

Still another object of an aspect of the invention is a method of forming an optical modulator having a photonic crystal region with an electrode island.

One aspect of the invention is an optical modulator comprising: a substrate, an optical buffer layer, an optical waveguide layer, a photonic crystal region formed on the optical waveguide layer and an electrode located proximate to the optical waveguide layer

Another aspect of the invention is a method of forming an optical modulator comprising the steps of depositing an optical buffer layer on a substrate, depositing an optical waveguide layer on the optical buffer layer, etching an array of holes in the optical waveguide layer in order to form the photonic crystal regions and undercutting the optical buffer layer under the photonic crystal regions in order to remove the optical buffer layer.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagram of a conventional Mach-Zehnder modulator.

FIG. 2(a) shows a top view of a photonic crystal based modulator in accordance with an embodiment of the present invention.

FIG. 2(b) shows a perspective view of the photonic crystal based modulator shown in

FIG. 2(a).

FIG. 3(a) shows a top view of the photonic crystal based modulator in accordance with another embodiment of the present invention.

FIG. 3(b) shows a perspective view of the photonic crystal based region of the modulator shown in FIG. 3(a).

FIG. 4(a) shows a top view of the photonic crystal based modulator in accordance with yet another embodiment of the present invention.

FIG. 4(b) shows a perspective view of the photonic crystal based region of the modulator shown in FIG. 4(a).

FIG. 5 shows a flow chart of the process for forming the modulator.

FIGS. 6(a)-6(d) show SEM micrographs of GaN photonic crystal waveguides in the optical waveguide layer.

FIG. 7(a) is a graph showing the calculated thickness for an AlₓGa₁₋ₓN optical buffer layer on Si.

FIG. 7(b) is a simulation of an optical field launched from the left into a 300 nm thick GaN optical waveguide layer separated from the Si substrate by a 1 μm thick buffer layer of AlₓGa₁₋ₓN where x corresponds to the composition with index of refraction n=2.3.

FIG. 7(c) is a simulation of an optical field launched from the left into a 300 nm thick AlN optical waveguide layer separated from the Si substrate by a 1 μm thick buffer layer of AlₓGa₁₋ₓN where x corresponds to the composition with index of refraction n=2.1.

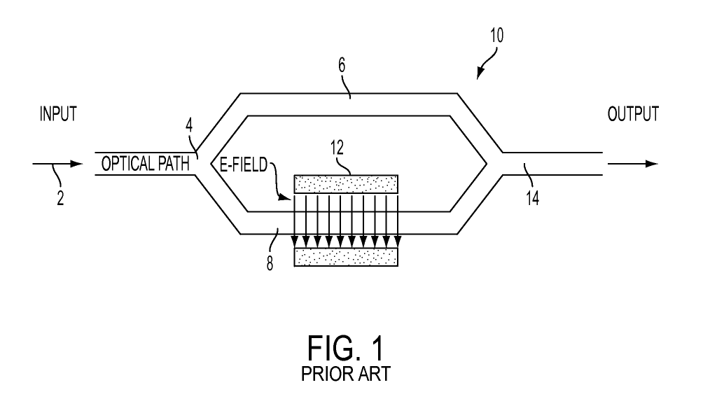

### DETAILED DESCRIPTION OF THE PREFERRED EMBODIMENTS

The difference between a conventional and a photonic crystal based Mach-Zehnder modulator lies in the dispersion properties of the component waveguides. Unlike conventional waveguides, photonic crystal waveguides can be designed and fabricated to produce very low group velocities. Since the path length associated with the modulator is proportional to the group velocity of the propagating light, device lengths on the order of micrometers are achievable when the group velocity approaches c/1000 (where c is the speed of light in vacuum). Achieving this group velocity is possible using photonic crystal waveguides (S G Johnson, P. R. Villeneuve, S. Fan and J. D. Joannopoulos, Phys. Rev. B 62, 8212 (2000); H. Altug and J. Vuckovic, Appl. Phys. Lett., 86, 111102 (2005); A. Martinez, P. Sanchis, and J. Marti, Optical and Quantum Electronics, 37, 77 (2005).

Such reduced device sizes enable the incorporation of Mach-Zehnder modulators into on-chip optical networks by allowing the size of the on-chip optical network to be sufficiently reduced so as to be compatible with electronic circuits and/or components. To achieve successful integration of such an optical network with Si based electronic circuits, the optical field must be kept confined within a waveguide layer separate from the Si substrate. The optical network can consist of both conventional and photonic crystal based optical components within the waveguide layer. However, it should be understood that in order to miniaturize as many optical components as possible it is preferable to maximize the use of photonic crystal components.

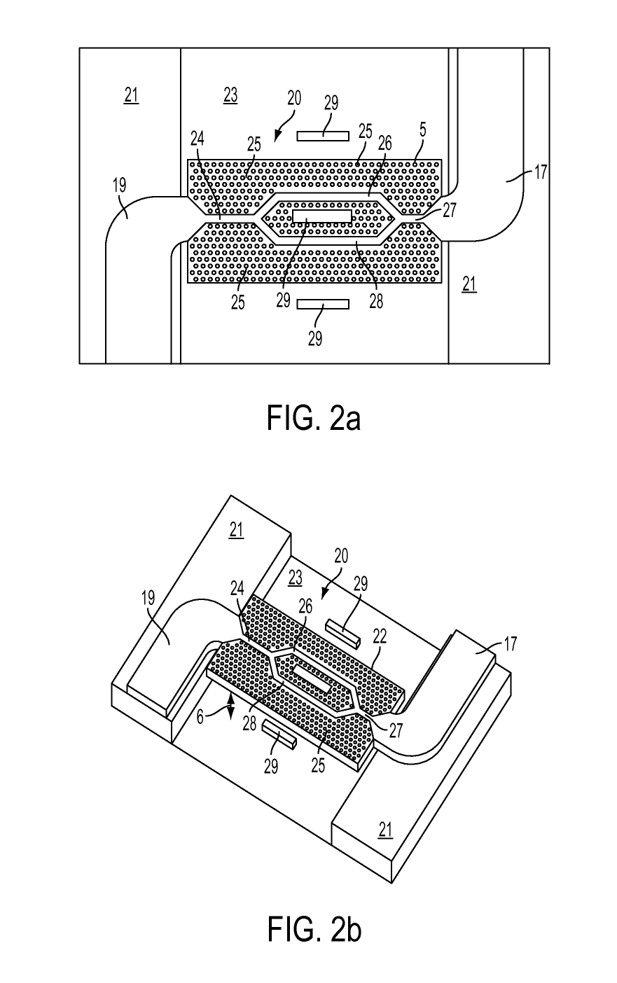

Shown in FIG. 2(a) is a modulator 20 that utilizes a photonic crystal region 25. The photonic crystal region 25 allows minimization of the size of modulator 20 by substantially reducing the dimensions of the optical waveguides 26 and 28. The photonic crystal region 25 is that portion of the optical waveguide layer 22 that has holes 5 etched through the layer 22. The modulator 20 has an optical waveguide layer 22 which in the embodiment shown in FIG. 2(a) comprises an input conventional optical waveguide 19, an input photonic crystal optical waveguide 24, a first photonic crystal optical waveguide 26, a second photonic crystal optical waveguide 28, an output photonic crystal optical waveguide 27 and an output conventional optical waveguide 17. Light travels through the modulator 20 and is modulated by application of an electric field across one or both of the waveguides 26 and 28.

The size of the device including the photonic crystal region 25 that is shown in FIG. 2 is determined by the periodicity of holes 5 etched in the photonic crystal region 25. This periodicity is comparable to the wavelength of light. The exact placement and size of the holes can be determined through established numerical techniques described (for example) in references mentioned above, and depend on such factors as the material properties and the wavelength region required for device operation. In FIG. 2(b) it is shown how the photonic crystal regions 25 are suspended over a Si substrate 23 and located adjacent to optical buffer layer 21. The substrate 23 may also be made of SOI, SiGe on Si, sapphire, GaAs, InP, GaP, among others. In this configuration, an air layer is used to separate the photonic crystal region 25 from the Si substrate 23, and an optical buffer layer 21 is used to separate conventional optical waveguides 17 and 19 from the Si substrate 23. The buffer layer 21 may be made of SiNx, SiO2, porous Si, or an ultrathin Si/thick SiOx layer. Both of these separations are required to confine the optical field to the optical waveguide layer 22, thus preventing the optical field from being radiated into the Si substrate 23 and disabling the device. The optical waveguide layer 22 may be made of LiNbO3, BaTiO3, SrTiO3, InN, ZnS, ZnSe, ZnO, GaAs, InP, GaP, or alloys thereof. Air bridge 6 is the amount of space between the photonic crystal regions 25 and the substrate 23. A drawback of the design illustrated in FIG. 2 is the overall structural fragility due to photonic crystal regions 25 being suspended over the substrate 23.

Photonic crystals are dielectric arrays, with periodicities on the scale of the wavelength of light. The photonic crystal regions 25 can be used to control the propagation of light in certain wavelength regions in order to produce photonic structures that support the appropriate localized modes used to guide optical waves. Photonic crystal regions which rely on two-dimensional arrays such as shown in the photonic crystal region 25 require high refractive index contrast with surrounding areas in order for the optical field to be confined to these regions and not be lost by radiation into the surrounding regions. Because this requires in practice that photonic crystal regions such as the photonic crystal region 25 consist of a high index (waveguide) layer surrounded by lower index regions above and below, regions such as photonic crystal region 25 are referred to as “photonic crystal slabs.” To maximize the index contrast, and therefore the confinement of the optical field, the surrounding low-index regions are best formed of air or vacuum, which have the lowest possible refractive index of approximately 1. Photonic crystal regions 25 can therefore be used for on-chip integration of optical networks. As illustrated in FIG. 2(b) this would typically require that the photonic crystal regions 25 be suspended over the substrate 23 which in the embodiment shown is preferably constructed of Si or Si with a compatible layer of oxide, metal, SiGe, etc. that might be present in a standard CMOS fabrication process. The substrate composition is in fact immaterial to this invention since the device is designed to isolate the optical field present in the waveguide layer 22 from the substrate 23. Therefore, any substrate composition would be compatible with this device. By being “suspended” it is meant that the photonic crystal regions 25 are surrounded above and below by air, or by a vacuum with an index approaching 1, which is the lowest physical value, in order to maximize the index contrast. This is especially true when the photonic crystal regions 25 are fabricated within a waveguide layer 22 consisting of a material with only a moderately high refractive index, such as GaN.

Still referring to FIG. 2, in addition to the requirement that the photonic crystal regions 25 be suspended and etched into the optical waveguide layer 22, electrodes 29 should be placed in close proximity, i.e. proximate, to the suspended photonic crystal regions 25, preferably with one electrode 29 being placed on top of a suspended photonic crystal region 25. The proximity maximizes the electric field obtained in the device for a given applied voltage, thus allowing operation of the device at as low an applied voltage as is consistent with its function.

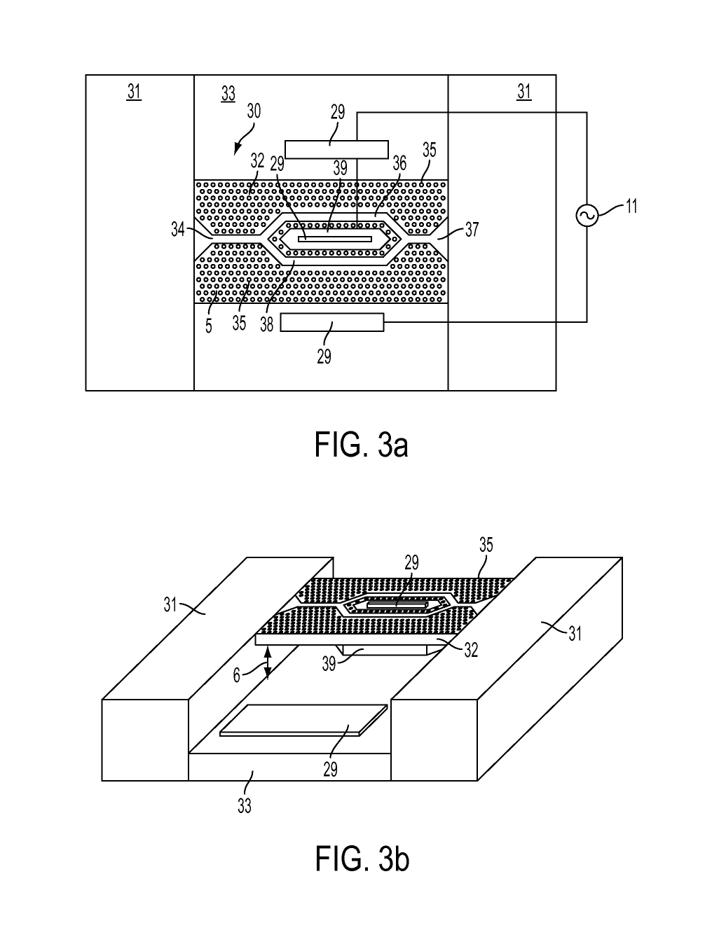

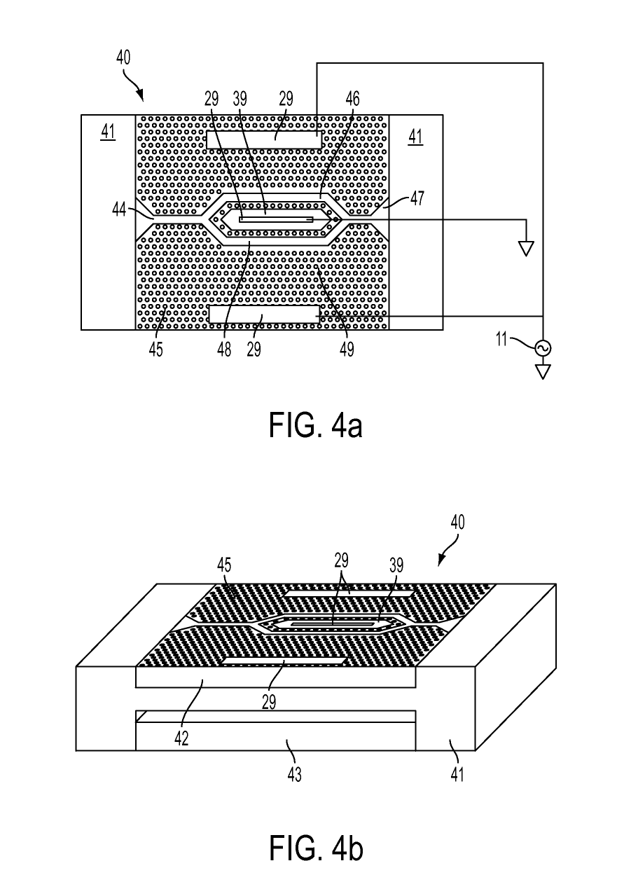

As noted above, the photonic crystal based Mach-Zehnder modulator 20 shown in FIGS. 2(a) and 2(b) is not as structurally and thermally desirable as the embodiments shown below in FIGS. 3(a)-4(b). The suspension of the photonic crystal region 25, in FIGS. 2(a) and 2(b) results in a fragile slab photonic crystal region 25. The embodiments discussed below address this drawback by eliminating the need to undercut outer regions of the device.

Referring now to FIGS. 3(a)-4(b), the modulators 30 and 40 eliminate the need to undercut any of the outer regions of the device, thus further improving the structural and thermal stability of the device by firmly anchoring the device to the substrate 33 or 43. For clarity, the surrounding conventional optical waveguides 17 and 19 are omitted in these views. The entire device described herein can potentially be fabricated by in-situ growth and patterning processes compatible with the manufacture of Si-based electronics. Suitable growth processes may include the deposition of an AlN optical buffer layer and a GaN optical waveguide layer by metal organic chemical vapor deposition (MOCVD), molecular beam epitaxy (MBE), hydride phase vapor epitaxy (HPVE), atomic layer deposition (ALD), or similar techniques. Patterning of the device may be accomplished, for example, by photolithography or e-beam lithography, patterning the photonic crystal regions by dry etching, and finally undercutting the structure by wet etching.

Shown in FIGS. 3(a)-4(b) are designs of photonic crystal based Mach-Zehnder modulators 30 and 40 that overcome the minor deficiencies noted above with respect to the modulator shown in FIG. 2. Both the modulator 30 and the modulator 40 provide a structurally sound manner for providing chip-scale miniaturization of optical networks employing photonic crystals.

The design shown in FIGS. 3(a) and 3(b) has better structural stability than the suspended photonic crystal region 25 of FIG. 2 while simultaneously meeting the functionality requirements. For clarity, the surrounding conventional optical waveguides are omitted in this view. The modulator 30 provides an on-chip method of integrating a modulator 30, based on the functionality of a Mach-Zehnder interferometer, with silicon based electronics since the modulator 30 can be fabricated with GaN films grown in-situ on silicon substrates.

The modulator 30 is formed with an optical waveguide layer 32 which is comprised of an input optical waveguide 34, a first optical waveguide 36, a second optical waveguide 38 and an output optical waveguide 37. Located in the center of the optical waveguide layer 32 are photonic crystal regions 35, which are formed via the etching of holes 5 through the optical waveguide layer 32. Optical waveguide layer 32, which includes photonic crystal regions 35, is located above substrate 33 but separated from it by the optical buffer layer 31. As shown in FIG. 3(b), the optical buffer layer 31 can be locally removed to create a suspended region sometimes referred to as an “air bridge 6.” The advantage of removing the optical buffer 31 layer below the photonic crystal regions 35 is that it results in maximizing the refractive index contrast, thereby enhancing the optical confinement of the light in those regions. However, there are also disadvantages in that partial removal of the optical buffer layer 31 results in mechanically weakening the optical waveguide layer 32 as well as thermally isolating it from the substrate. To address these disadvantages, an electrode island 39 is located in the center of the photonic crystal region 35 and extends beneath the lower surface of the optical waveguide layer 32 and the photonic crystal regions 35 anchoring them to the substrate 33. An electrode material is deposited onto the upper surface of the electrode island 39, thereby forming an electrode 29 atop of the electrode island 39. Another electrode 29 is located on the substrate 33. In operation, light is transmitted through the modulator 30 via the paths 36, 38 while an electric field is applied between the electrodes 29.

In order to provide the functionality of a Mach-Zehnder modulator, an electric field is applied across one or both of the optical waveguide paths 36, 38. This is accomplished by forming an electrode 29 on the electrode island 39 in the center of modulator 30. Electrode island 39 provides a position on the surface of the optical waveguide layer 32 where an electrode material is deposited in order to form an electrode 29 on top of the electrode island 39. The electrode 29 can be any conducting material such as any metal or properly doped semiconducting layer. Corresponding electrodes 29 are deposited outside the suspended photonic crystal regions 35, as shown in FIGS. 3(a) and 3(b). This design allows either the first optical waveguide path 36 or the second optical waveguide path 38, or in an alternative embodiment both the first and the second optical waveguide paths 36, 38 (the latter being practical when the linear electro-optic effect is employed as shown in FIGS. 4(a) and 4(b)) of the modulator 30 to be modulated via an electric field applied across electrode island 39 and electrode 29.

An advantage of this Mach-Zehnder type modulator 30 is that the electrode island 39 in the center also provides structural support for the suspended photonic crystal region 35. This is because during the fabrication process the optical buffer layer under the central portion of the photonic crystal region 35 is not removed and forms the electrode island 39. In this design, only the photonic crystal regions 35 are suspended, rather than the entire modulator 30, making it more structurally and thermally stable than the embodiment of FIG. 2(a). The conventional waveguides 17, 19 shown in FIG. 2 need not be suspended.

Another embodiment of the modulator is shown in FIGS. 4(a) and 4(b). The modulator 40 has the outer electrodes 29 located at the same height as the electrode 29 formed on the electrode island 39 and further increases the structural and thermal stability in view of the design shown in FIG. 2(a). The modulator 40 is formed with an optical waveguide layer 42, which comprises an input optical waveguide 44, a first optical waveguide 46, a second optical waveguide 48 and an output optical waveguide 47. Located in the central region of the optical waveguide layer 42 are photonic crystal regions 45. The optical waveguide layer 42 and the photonic crystal regions 45 formed in the optical waveguide layer 42 are located adjacent the Si substrate 43 and optical buffer layer 41. The electrode island 39 is located in the center area of the photonic crystal regions 45. In this embodiment, the electrodes 29 are located on the optical waveguide layer 42.

Still referring to FIG. 4, the electrode 29 is deposited outside both the first optical waveguide 46 and the second optical waveguide 48. In practice, both of the electrodes 29 can provide modulation (e.g., in a device based on the linear electro-optic effect) out of phase with each other, or relative to the electrode island 39 in the center of the modulator 40. As noted above, the two electrodes 29 and the electrode 29 placed on the electrode island 39 are deposited (i.e. fabricated) on top of the optical waveguide layer 42 and the regions where these electrodes are located are not undercut, thus allowing for additional structural and thermal support of the optical waveguide layer 42 since only the area under the photonic crystal region 45 is undercut. The undercutting is achieved by removing the optical buffer layer 41 under the photonic crystal regions 45, and only in those regions. This is preferably accomplished by a wet etch which proceeds through the previously patterned array of holes 5 that make up the photonic crystal regions 45 of the optical waveguide layer 42.

With respect to the modulators 20, 30 and 40, the optical buffer layers 21, 31 and 41 can be any optically transparent material that has a refractive index lower than the optical waveguide layers 22, 32 and 42. Such materials include but are not limited to SiO2, SiNx, porous Si, and composites consisting of multiple layers with various indices where the thickness of each layer is much less than a wavelength of light. The optical buffer layers 21, 31 and 41 can also be formed by selectively doping the top layer of the substrate by ion implantation and/or diffusion. The optical buffer layers 21, 31 and 41 may also have the characteristics of being able to be isotropically removed in order to suspend the photonic crystal regions 25, 35 and 45 and may also be grown in the form of a smooth film of sufficient thickness on the substrate containing the electronic circuits.

The optical waveguide layers 22, 32 and 42 may be any dielectric material that has the following characteristics: (1) an index of refraction higher than that of the optical buffer layers 21, 31 and 41, (2) transparency in the wavelength region of interest, (3) a suitable electro-optic coefficient or may be formed into a p-n junction to modify the refractive index in response to an applied electric field, (4) may be grown in the form of an optical-quality thin film on the optical buffer layers 21, 31, and 41, and (5) may be anisotropically patterned into a photonic crystal structure that in turn can survive removal of the optical buffer layer under the patterned region. A suspended structure is not required in any region of this device if the indices of refraction of the optical buffer layers 21, 31 and 41 are sufficiently small compared to those of the optical waveguide layers 22, 32 and 42. A symmetric index profile is not required (i.e. asymmetry can be tolerated), but a symmetric profile is known to give optimal confinement of the optical field in both conventional and photonic crystal waveguides. In addition to their utility as modulators, Mach-Zehnder interferometers have applications in strain measurement and other optical sensors that detect mechanical, electronic and chemical properties.

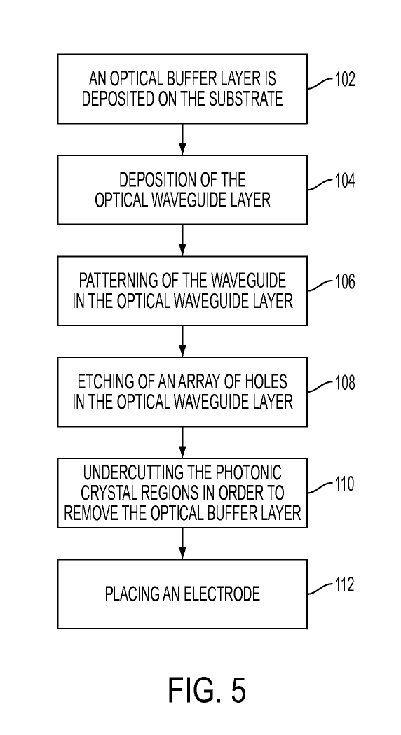

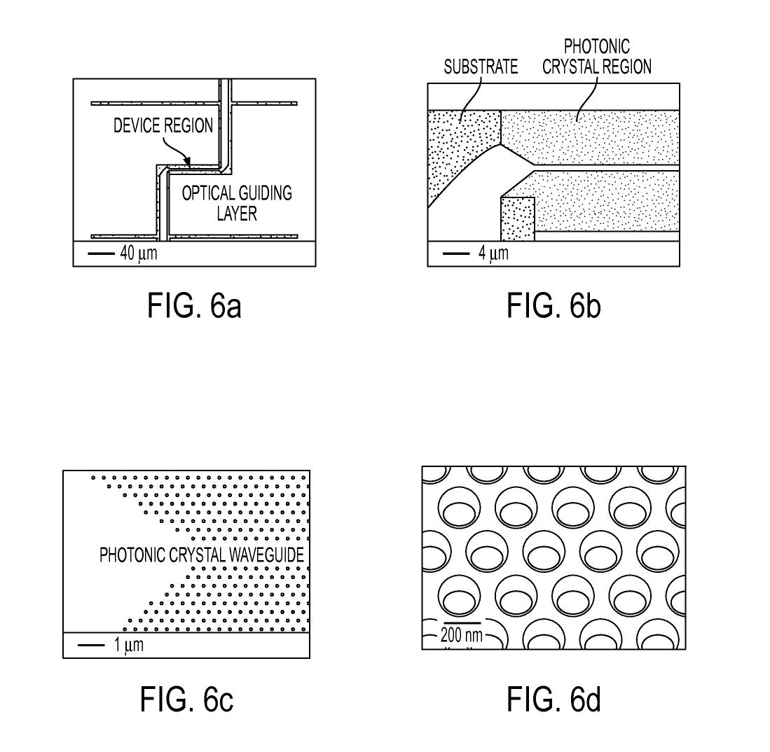

In FIG. 5 the method of forming the modulators shown in FIGS. 3(a), 3(b) and 4 is shown. For modulators 30 and 40 discussed above, the formation of the GaN based optical waveguide layers integrated with Si electronics is performed in the following manner. In step 102 an optical buffer layer of AlN is deposited by, for example, MOCVD on top of a substrate 31 or 41 that is preferably constructed of Si. In step 104 optical waveguide layer 32 or 42 of GaN is deposited atop optical buffer layer 31 or 41. In Step 106 the optical waveguide layer 32 and 42 is patterned to produce conventional (ridge) waveguides that link the Mach-Zehnder modulator with the rest of the chip. In step 108, in order to produce the photonic crystal regions 35 and 45, arrays of holes are etched through regions of the conventional optical waveguides. In the embodiments shown in FIGS. 3(a)-4(b), each array of holes is formed with paths of “defects” so that photonic crystal waveguides are created in a “loop” arrangement to create a Mac-Zehnder modulator as shown in FIGS. 2(a)-4(b). The photonic crystal waveguides are created by eliminating or modifying rows of holes from the array. The exact placement and size of the holes is determined by established numerical techniques. Photonic crystal waveguides may involve changes to several adjacent lines of holes in order to obtain the desired dispersion properties and group velocity. An example of such an array including both conventional and photonic crystal waveguides fabricated in GaN is shown in FIGS. 6(a)-6(d).

Specific rows of holes may be modified to create three-dimensionally confined photonic crystal based waveguides, as shown in FIGS. 6(a)-6(d). FIGS. 6(a)-6(d) show SEM (scanning electron microscope) micrographs of GaN photonic crystal regions in the optical waveguide layer. FIG. 6(a) shows conventional waveguides along with a photonic crystal region. FIG. 6(b) shows a higher magnification image of the transition from the conventional waveguide to the photonic crystal region. FIG. 6(c) shows a GaN photonic crystal region. FIG. 6(d) shows a high magnification image of the triangular array of holes that define the GaN photonic crystal region.

In step 110, the photonic crystal regions 35 and 45 may be undercut by a wet KOH etch in order to remove the optical buffer layer 31, 41 in those regions, thus forming suspended structures that have a refractive index profile that is both symmetric and maximized. This refractive index profile has the effect of maximizing the widths of the photonic band gaps, thereby increasing flexibility of the device and reducing fabrication tolerances. An asymmetric index profile in the photonic crystal region narrows the photonic band gaps which are required to confine the optical field, but small asymmetries may be tolerated in the operation of the modulators 30 and 40.

In step 112, electrodes 29 are placed on a substrate, an optical waveguide layer and/or an electrode island 39. The electrodes 29 are placed in locations proximate to the optical waveguide layers 32 and 42. In the modulator 40, the electrodes 29 used are placed on the optical waveguide layer 42. In modulators 30 and 40, electrodes are also placed on the electrode island 39, located in the central region of the optical waveguide layers 32 and 42.

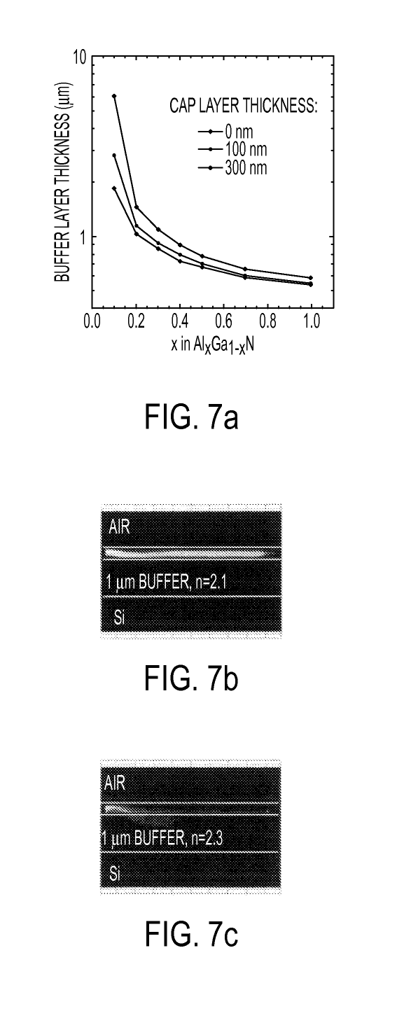

The optical buffer layers 31 and 41 may have sufficient thickness and appropriately lower refractive index than the optical waveguide layers 32 and 42. The thickness and index are not independent parameters. The higher the index difference, the lower the required thickness, as shown by the calculation in FIG. 7(a). This maintains confinement of the optical field in the regions of conventional optical components, as described below. In the regions where photonic crystal components exist, the optical buffer layers may have to be removed (e.g. undercut via etching) in order to provide the higher index contrast required by the photonic crystal waveguides.

FIGS. 7(a)-7(c) are graphical and diagrammatical illustrations of the results of exemplary embodiments of the modulators 30 and 40. FIG. 7(a) is a graph illustrating the calculated thickness for an AlₓGa₁₋ₓN optical buffer layer between a Si substrate and a 300 nm thick GaN waveguide layer (with a cap layer having the same composition) that is required to obtain a loss of less than 1 dB/cm for optical propagation in the optical waveguide layer. To illustrate the effect of a relatively high-index optical buffer layer, FIG. 7(b) shows a simulation of an optical field launched from the left into a 300 nm thick GaN optical waveguide layer separated from the Si surface by a 1 micrometer optical buffer layer of AlₓGa₁₋ₓN having high Ga content (specified by the index of refraction, 2.3). In this case, the optical field is quickly radiated into the Si substrate. By contrast, FIG. 7(c) illustrates the effect of a relatively low-index optical buffer layer by showing a simulation using the same structure in the same manner as that which is shown in FIG. 7(b) but with an AlN (n=2.1) optical buffer layer. It should be noted that the optical field is confined to the GaN optical waveguide layer in FIG. 7(c).

Photonic crystal based Mach-Zehnder optical modulator integrated with Si, such as those shown above in FIGS. 3(a), 3(b), 4(a) and 4(b), rely on the special optical properties of photonic crystal waveguides to reduce the dimensions of the device to a few micrometers instead of the hundreds of micrometers in width and millimeters in length that are required for conventional Mach-Zehnder optical modulators. Because the dispersion of the photonic crystal region can be controlled by patterning of the photonic crystal regions it can be used to reduce the group velocity in this region and thereby compensate for a reduced electro-optic coefficient. Therefore, materials with lower electro-optic coefficients can be used to form modulators 20, 30 and 40. For example, the electro-optic coefficients of GaN are approximately 1/10 of those for LiNbO₃, which is currently the most commonly used material in commercial Mach-Zehnder optical modulators based on conventional waveguide designs. However, it has been shown that group velocities of c/1000 or less are achievable with photonic crystal waveguides (where c is the speed of light in vacuum) this implies that a Mach-Zehnder modulator incorporating photonic crystal waveguides can shrink to a size of 1/100 or less of a Mach-Zehnder modulator that relies entirely on conventional waveguides, as is the case with all currently available commercial devices. Furthermore, by incorporating an electrode island, such as electrode islands 39 and 49 discussed above, between the first optical waveguide 36 and 46 and the second optical waveguide 38 and 48, the entire device need not be suspended, thus making it it thermally and mechanically stable. In particular, this design makes it unnecessary to place electrodes on top of suspended structures, which is a potentially troublesome step in the fabrication process and a likely cause of device failure in practical use. The only suspended structures in the embodiments shown in FIGS. 3(a), 3(b) and 4 are the photonic crystal regions 35 and 45, which renders the mechanical and thermal robustness of the device more suitable for practical applications. The central electrode islands 39 and 49 also provide structural support to the suspended optical waveguide layers 32 and 42 by remaining attached to the Si substrates 33 and 43 via the optical buffer layers 31 and 41.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. An optical modulator comprising:
a substrate;
an optical buffer layer;
an optical waveguide layer;
a photonic crystal region formed in the optical waveguide layer; and
an electrode located proximate to the optical waveguide layer.

2. The optical modulator of claim 1, further comprising an electrode island located proximate a central region of the optical waveguide layer.

3. The optical modulator of claim 2, further comprising a second electrode located proximate to the optical waveguide layer.

4. The optical modulator of claim 3, wherein the electrodes are located on the optical waveguide layer.

5. The optical modulator of claim 1, further comprising;
an input optical waveguide path,
a first optical waveguide path located adjacent to the input optical waveguide path;
a second optical waveguide path located adjacent to the input optical waveguide path; and
an output optical waveguide path located adjacent to the first and second optical waveguide paths.

6. The optical modulator of claim 5, wherein a central region lies between the first and second optical waveguide paths and an electrode island is located within the central region.

7. The optical modulator of claim 5, wherein the first and second optical waveguide paths pass through the photonic crystal regions.

8. The optical modulator of claim 1, wherein the substrate material is selected from the group consisting of silicon SOI, SiGe on Si, sapphire, GaAs, InP, and GaP.

9. The optical modulator of claim 8, wherein the optical waveguide layer is selected from the group consisting of GaN, LiNbO3, BaTiO3, SrTiO3, InN, ZnS, ZnSe, ZnO, GaAs, InP, GaP, and alloys thereof.

10. The optical modulator of claim 1, wherein the substrate comprises silicon, the photonic crystal region comprises GaN and the optical buffer layer comprises AlN.

11. A method of forming an optical modulator comprising the steps of:
depositing an optical buffer layer on a substrate;
depositing an optical waveguide layer on the optical buffer layer,
etching an array of holes in the optical waveguide layer in order to form photonic crystal regions;
undercutting the optical buffer layer under the photonic crystal regions in order to remove the optical buffer layer; and
placing at least one electrode.

12. The method of claim 11, further comprising the step of locating an electrode island proximate to a central region of the optical waveguide layer.

13. The method of claim 12, further comprising the step of locating a second electrode proximate to the optical waveguide layer.

14. The method of claim 13, wherein the first and second electrodes are located on the optical waveguide layer.

15. The method claim 11, further comprising the steps of;
forming an input optical waveguide path in the optical waveguide layer,
forming a first optical waveguide path adjacent to the input optical waveguide path;
forming a second optical waveguide path adjacent to the input optical waveguide path; and
forming an output optical waveguide path adjacent to the first and second optical waveguide paths.

16. The method of claim 15, wherein a central region is located between the first and second optical waveguide paths and an electrode island is located within the central region.

17. The method of claim 15, wherein the first and second optical waveguide paths are formed in the photonic crystal regions.

18. The method of claim 11, wherein the substrate material is selected from the group consisting of SOL sapphire, SiGe on Si, GaAs, InP, GaP, and alloys thereof.

19. The method of claim 18, wherein the optical waveguide layer is selected from the group consisting of GaN, LiNbO3, BaTiO3, SrTiO3, InN, ZnS, ZnSe, ZnO, GaAs, InP, GaP, and alloys thereof.

20. The method of claim 11, wherein the substrate comprises silicon, the photonic crystal region comprises GaN and the optical buffer layer comprises AlN.
